(19) United States
(12) Patent Application Publication
(10) Pub. No.: US 2005/0009554 A1
(43) Pub. Date: Jan. 13, 2005

(54) Data transmission system with adjustable transmission power

(76) Inventor: Bernd Schmandt, Wuppertal (DE)

Correspondence Address: Andreas Grubert;Baker Botts L.L.P., One Shell Plaza, 910 Louisiana, Houston, TX, 77002-4495, US

(21) Appl. No.: 10/911,811

(22) Filed: Aug. 5, 2004

Related U.S. Application Data
(63) Continuation of application No. PCT/DE03/00147, filed on Jan. 20, 2003.

(30) Foreign Application Priority Data
Feb. 6, 2002 (DE) 102 04 851.7

(51) Int. Cl. H04Q 7/20

(52) U.S. Cl. 455/522; 455/517

(57) ABSTRACT

A data transmission system has a first terminal device (H) and a second terminal device (Ni) between which data (DLi, ULi) can be transmitted via a radio link. The first terminal device (H) contains control means (S) for timed increase of the transmission power for sending data (DLi) up to a time which is determined as a result of the presence of the radio link being established.

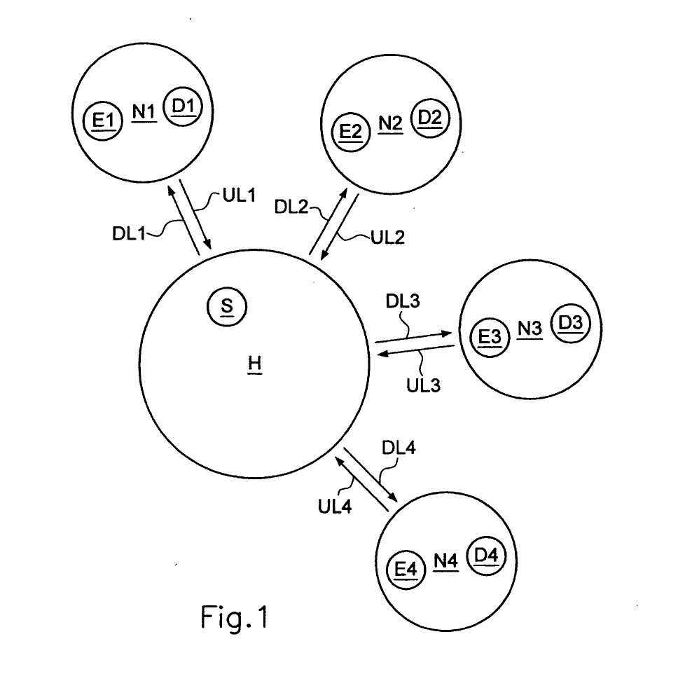

### CROSS REFERENCE TO RELATED APPLICATION

This application is a continuation of copending International Application No. PCT/DE03/00147 filed Jan. 20, 2003 which designates the United States, and claims priority to German application no. 102 04 851.7 filed Feb. 6, 2002.

### TECHNICAL FIELD OF THE INVENTION

The invention relates to a data transmission system and a method for establishing the necessary transmission power in this data transmission system. The data transmission system comprises at least two terminal devices between which data packets are interchanged by radio.

### BACKGROUND OF THE INVENTION

Such data transmission systems in which data packets are interchanged between at least two terminal devices by radio over just short distances are referred to as piconetworks, particularly in the Bluetooth standard. By way of example, the base part and the mobile part of a cordless telephone or a computer and peripheral devices connected thereto via the air interface are respective piconetworks.

In the Bluetooth standard, data packets are interchanged between a primary terminal device (master) and a number of ancillary terminal devices (slaves). Data transmission from the primary terminal device to the ancillary terminal devices is called a downlink. The opposite case of data transmission from the ancillary terminal devices to the primary terminal device is referred to as an uplink.

In the Bluetooth standard, a terminal device does not need to be stipulated as a primary terminal device or as an ancillary terminal device from the outset. By way of example, provision may also be made for that terminal device which, following startup or activation of the data transmission system in question, is the first terminal device to transmit data to another terminal device to be the primary terminal device. The other terminal devices are then the ancillary terminal devices.

In the Bluetooth standard, various power classes are prescribed for the transmission powers in the terminal devices. The power classes are divided into power class 1, power class 2 and power class 3. In this context, the respective transmission power increases as the order of the power class falls. Consequently, power class 1 is the most powerful power class. For power class 1, the Bluetooth standard prescribes power regulation which is intended to prevent transmission powers which are too high from having a disturbing effect on other transmission and reception devices or other electrical equipment. The power regulation is performed by virtue of the receiver notifying the transmitter of the signal strength which it has measured, so that the transmitter can readjust its transmission power accordingly.

During connection setup between the primary terminal device and the ancillary terminal devices, such power regulation cannot be performed, since at this time there is still no return channel which could be used to transmit a control signal.

It is therefore an object of the invention to provide a data transmission system which is based on the Bluetooth standard, in particular, and can be used to set a transmission power which is as low as possible during the actual connection setup between the terminal devices. In addition, the intention is to specify a method for a data transmission system which can be used to establish the necessary transmission power within the data transmission system.

### SUMMARY OF THE INVENTION

The object on which the invention is based can be achieved by a method for establishing the necessary transmission power in a data transmission system which has a first terminal device and a second terminal device between which data are transmitted by radio, comprising the steps of:
(a) transmitting consecutive test data packets by the first terminal device, with the transmission power in the first terminal device rising in prescribed fashion over time; and
(b) transferring a reception confirmation data packet from the second terminal device to the first terminal device following reception of a test data packet, subsequently called initialization data packet, for the first time and further processing of the first initialization packet by the second terminal device, wherein the test data packets contain information about the respective transmission power which is used to transmit them.

The first terminal device may essentially use a constant transmission power, following reception of the reception confirmation data packet, for transferring further data packets to the second terminal device. The first terminal device may transmit the further data packets to the second terminal device essentially using the same transmission power as that which was used to transmit the initialization data packet. The transmission power which was used to transmit the initialization data packet can be stored by the first terminal device. When the method has concluded and the method is started again the first terminal device may transmit the first test data packet to the second terminal device using the stored transmission power. Reception of the initialization data packet may prompt the second terminal device to read the information about the transmission power which was used to transmit the initialization data packet, and the second terminal device may send the reception confirmation data packet and, in particular, further data packets to the first terminal device using the same transmission power as the transmission power used for the initialization data packet. The data transmission system can be based on the Bluetooth standard, and the first terminal device can be the primary terminal device and the second terminal device is an ancillary terminal device. The method may be used while the data transmission system is being started up from the off state or at least an inactive state.

The object can also be achieved by a method for establishing the necessary transmission power in a data transmission system which has a first terminal device and a plurality of second terminal devices between which data are transmitted by radio, comprising the steps of:
(a) transmitting consecutive test data packets to each second terminal device by the first terminal device, with the transmission power in the first terminal device rising in prescribed fashion over time until the first device has received from each of the second terminal devices a reception confirmation data packet which has been transferred in line with method step b),
(b) transferring a reception confirmation data packet from one of the second terminal devices to the first terminal device following reception of a test data packet, subsequently called initialization data packet, for the first time and further processing of the initialization packet by the respective second terminal device, and
(c) storing the respective transmission power required for reception for each of the second devices in a table.

The stored transmission power can be used for later connection setup to the respective second device. The first terminal device may send further data packets to a second terminal device using a transmission power which is determined by the initialization data packet associated with this second terminal device. The data transmission system can be based on the Bluetooth standard, the first terminal device can be the primary terminal device and the second terminal devices are ancillary terminal devices, and the primary terminal device may operate in the Bluetooth-specific inquiry mode during method steps a) to c). The method can be used while the data transmission system is being started up from the off state or at least an inactive state.

A data transmission system in line with the invention comprises a first terminal device and a second terminal device. Between the two terminal devices, it is possible to transmit data by radio. The two terminal devices therefore each have both transmission and reception means. A fundamental concept of the invention is that the first terminal device comprises control means which are designed such that they increase the transmission power in the first terminal device in prescribed fashion over time when data are being sent. This timed transmission power increase is performed up to a time which is determined by virtue of it having been established that there is a radio link between the two terminal devices.

The inventive data transmission system has the advantage that it can be used to transmit data using just a low transmission power during connection setup too. By way of example, provision may be made for connection setup to prompt the first terminal device to use the control means to send data in the form of data packets to the second terminal device and for consecutive data packets to be sent using a progressively increasing transmission power. The second terminal device receives the first data packet as soon as the transmission power is high enough for this. Next, the increase in the transmission power in the first terminal device is aborted. This allows the first terminal device to set its transmission power to a level which is as low as possible but is still sufficient for the data packets which it transmits to be received by the second terminal device. This minimizes disturbing influences on other transmitters as a result of unnecessarily high transmission powers.

The time at which the transmission power increase is aborted may be determined in various ways. By way of example, it is conceivable for the transmission power increase to be stopped only at the time at which a user data packet has been transmitted from the second terminal device to the first terminal device for the first time after the connection has been set up. Alternatively, however, provision may preferably be made for the second terminal device to have detection means whose task is to establish successful reception of data which have been transmitted by the first terminal device. Following detection of this kind, reception confirmation means in the second terminal device would preferably be able to transmit a reception confirmation to the first terminal device. This would notify the first terminal device that the connection has been set up and would allow it to abort the transmission power increase. If desired, the second terminal device would also be able to indicate to the first terminal device that the connection has been set up just by virtue of the first time a user data packet is transmitted.

In line with one particularly advantageous refinement of the invention, the control means, the detection means and the reception confirmation means interact such that the reception confirmation means notify the control means that the connection has been set up as soon as this has been established by the detection means. This allows the control means to terminate the transmission power increase thereafter. Consequently, this measure ensures that the transmission power has as low a value as possible but one which is still sufficient for transmitting data.

Advantageously, the timed transmission power increase may correspond to a rising ramp function or to a rising staircase function.

Although provision may be made for the inventive data transmission system to be based, by way of example, on the DECT (Digital European Cordless Telecommunications) standard or on the WDCT (Worldwide Digital Cordless Telecommunications) standard, another particularly advantageous refinement of the invention provides for the data transmission system to be based on the Bluetooth standard and for one of the two terminal devices to be the primary terminal devices and the other terminal device to be an ancillary terminal device. In this case, either the primary terminal device or the ancillary terminal device may be equipped with the properties of the first or of the second terminal device. In addition, it is conceivable for both the primary terminal device and the ancillary terminal device to contain respective control means, detection means and reception confirmation means. In that case, it would be possible for the transmission power to be set from both terminal devices. In addition, in the Bluetooth standard, the number of ancillary terminal devices would be able to be built up to the maximum number prescribed by the standard.

The inventive method is used to establish the transmission power required for a data transmission system, where the data transmission system has a first terminal device and a second terminal device. Data are interchanged between the first terminal device and the second terminal device by radio. The inventive method comprises two method steps. In a first step, consecutive test data packets are transmitted by the first terminal device. In this case, the transmission power in the first terminal device is increased in prescribed fashion over time. In a second method step, the second terminal device sends a reception confirmation data packet to the first terminal device. This is done as soon as a test data packet has been received by the second terminal device for the first time after the method started. The test data packet received by the second terminal device for the first time within a sweep of the inventive method is referred to as the initialization data packet.

The inventive method has the advantage that the reception confirmation data packet notifies the first terminal device of what transmission power is sufficient for transmitting data to the second terminal device by radio.

By way of example, the first terminal device may, following reception of the reception confirmation data packet, keep the transmission power for transmitting further data packets to the second terminal device by radio essentially constant. This ensures that the transmission power in the first terminal device is always at a level which is such that there is radio contact with the second terminal device. At the same time, it ensures that the first terminal device does not adversely affect other receivers as a result of an unnecessarily high transmission power. Alternatively, provision may likewise be made for reception of the reception confirmation data packet to be followed by activation of a regulating unit whose task is to keep the transmission power at a nominal value or at a value which is as low as possible, for example. Such a regulating unit may now be used, since a return channel exists.

In line with another advantageous refinement of the invention, the further data packets are transmitted to the second terminal device by the first terminal device using essentially the transmission power which was also used for the initialization data packet. As a result, the further data packets are transmitted using the minimum transmission power required for successful transmission, and disturbing influences are minimized accordingly.

One particularly advantageous refinement of the invention provides for the transmission power which was used to transmit the initialization data packet to be stored by the first terminal device. Advantageously, data packets can then be sent to the second terminal device using the stored transmission power as soon as, by way of example, the connection between the first and the second terminal device has been interrupted and needs to be set up again. This measure makes it a simple matter to find the necessary transmission power when setting up the connection again. Preferably, the first test data packet when setting up a connection again can be transmitted using the stored transmission power.

In line with one preferred refinement of the invention, a test data packet respectively contains information about the transmission power which was used to transmit it. This means that it is possible for this information to be read at the receiver end as well. Preferably, provision may then be made for the second terminal device to read this information from the initialization data packet when the initialization data packet is received. The second terminal device can use this information to send, for its own part, the reception confirmation data packet and, in particular, further data packets intended for the first terminal device using the same transmission power as that which was used previously to transmit the initialization data packet from the first terminal device. This ensures that the second terminal device also transmits using just the minimum transmission power required.

One particularly preferred refinement of the invention is characterized in that the data transmission system has a plurality of second terminal devices. The first terminal device sends test data packets to each of the second terminal devices. As soon as the transmission power in the first terminal device is sufficiently high for transmitting an initialization data packet to a second terminal device, the second terminal device in question returns a reception confirmation data packet to the first terminal device, whereupon the first terminal device in turn sends all further data packets to this second terminal device preferably using a transmission power which is determined by the transmission power for the initialization data packet. The transmission power increase in the first terminal device is terminated as soon as reception confirmation data packets have arrived from each of the second terminal devices.

The inventive method can preferably be based on the Bluetooth standard, with one of the two terminal devices taking responsibility for the function of the primary terminal device and the other terminal device taking responsibility for the function of an ancillary terminal device.

The inventive method is suitable, in a particularly advantageous manner, for accomplishing connection setup when the inventive data transmission system is started up from the off state or at least from an inactive state. When the inventive data transmission system has been started up using the inventive method, the transmission power may be set by feedback control, as prescribed in power class 1 in the Bluetooth standard, for example, since a return channel is now available.

### BRIEF DESCRIPTION OF THE DRAWING

The invention is explained in more detail below with reference to the drawing. In the drawing, the single FIGURE shows a schematic diagram of an exemplary embodiment of the inventive data transmission system which operates in line with the inventive method.

### DESCRIPTION OF THE INVENTION

The data transmission system shown schematically in the FIGURE is based on the Bluetooth standard. Between a primary terminal device H and ancillary terminal devices Ni (i=1, 2, 3, 4), data packets can be interchanged by radio. In this case, the data transmission can take place bidirectionally from the primary terminal device H to the ancillary terminal devices Ni, and vice versa. Possible downlinks DLi and uplinks ULi, which respectively transmit data from the primary terminal device H to the ancillary terminal device Ni and from the ancillary terminal device Ni to the primary terminal device H, are shown in the FIGURE.

In the present exemplary embodiment, the primary terminal device H is able to increase its transmission power for transmitting the downlinks Di over time. To this end, the primary terminal device H has a control unit S which can be used to control the transmission power and, in particular, to increase it with prescribed timing. In addition, the ancillary terminal devices Ni each have detection units Di which are used to establish data transmission emanating from the primary terminal device H. The detection units Di may be implemented in hardware in the ancillary terminal devices Ni, but they may also be provided in software and, by way of example, may be contained in an algorithm which is integrated in the reception and data processing software of the ancillary terminal devices Ni. In addition, the ancillary terminal devices Ni each have a reception confirmation unit Ei. The task of the reception confirmation units Ei is to confirm to the primary terminal device H a successful downlink DLi. Just like the detection units Di, the reception confirmation units Ei may be implemented either in hardware or in software.

The above described properties of the primary terminal device H and of the ancillary terminal devices Ni allow the inventive method to be applied to the data transmission system. In the present exemplary embodiment, the inventive method is used to set up connections between the primary terminal device H and the ancillary terminal devices Ni. In particular, it sets up the radio links between the primary terminal device H and the ancillary terminal devices Ni when the data transmission system is started up from an inactive state.

Connection setup within the present data transmission system can be accomplished in two different modes. In a “paging mode”, a connection between the primary terminal device H and a selected ancillary terminal device Ni is set up directly. A “inquiry mode” serves to provide the primary terminal device H with information about the ancillary terminal devices Ni.

Both in the paging mode and in the inquiry mode, the primary terminal device H first transmits test data packets. These test data packets are transmitted in succession, with the transmission power for the first test data packet being able to be prescribed, for example. The subsequent test data packets are respectively transmitted using a transmission power which is higher than the transmission power used for the preceding test data packet. In this case, the transmission power can be increased by the control unit S in ramp form or in staircase form, for example. In the paging mode, the test data packets are sent to one particular ancillary terminal device Ni, while a plurality of ancillary terminal devices Ni or else all of the ancillary terminal devices Ni in the data transmission system are addressed in the inquiry mode.

As soon as a test data packet has been received by the selected ancillary terminal device Ni in the paging mode or by an arbitrary ancillary terminal device Ni in the inquiry mode, the downlink DLi in question has been set up. This is established by the detection unit Di in question and, as reception confirmation, the reception confirmation unit Ei in question returns a reception confirmation data packet to the primary terminal device H. This notifies the primary terminal device H of successful reception of the test data packet in question, and the primary terminal device H can send all other data packets to the ancillary terminal device Ni in question using the same transmission power.

In inquiry mode, the transmission power increase over time in the primary terminal device H causes all selected ancillary terminal devices Ni to respond to the primary terminal device H in succession by transferring reception confirmation data packets. The transmission powers which are thus ascertained by the primary terminal device H and are required for the respective ancillary terminal devices Ni are stored in a table, for example. The transmission powers ascertained in this manner may be used again for later connection setup, for example. In addition, the stored transmission powers may be used as starting transmission powers for the ancillary terminal devices Ni in question if, when a connection is set up again later, the connections to the ancillary terminal devices Ni again need to be set up using a transmission power which increases at the transmitter end.

1. A method for establishing the necessary transmission power in a data transmission system which has a first terminal device and a second terminal device between which data are transmitted by radio, comprising the steps of:
(a) transmitting consecutive test data packets by the first terminal device, with the transmission power in the first terminal device rising in prescribed fashion over time; and
(b) transferring a reception confirmation data packet from the second terminal device to the first terminal device following reception of a test data packet, subsequently called initialization data packet, for the first time and further processing of the first initialization packet by the second terminal device, wherein the test data packets contain information about the respective transmission power which is used to transmit them.

2. The method as claimed in claim 1, wherein the first terminal device essentially uses a constant transmission power, following reception of the reception confirmation data packet, for transferring further data packets to the second terminal device.

3. The method as claimed in claim 2, wherein the first terminal device transmits the further data packets to the second terminal device essentially using the same transmission power as that which was used to transmit the initialization data packet.

4. The method as claimed in claim 1, wherein the transmission power which was used to transmit the initialization data packet is stored by the first terminal device.

5. The method as claimed in claim 4, wherein when the method has concluded and the method is started again the first terminal device transmits the first test data packet to the second terminal device using the stored transmission power.

6. The method as claimed in claim 1, wherein
reception of the initialization data packet prompts the second terminal device to read the information about the transmission power which was used to transmit the initialization data packet, and
the second terminal device sends the reception confirmation data packet and, in particular, further data packets to the first terminal device using the same transmission power as the transmission power used for the initialization data packet.

7. The method as claimed in claim 1, wherein
the data transmission system is based on the Bluetooth standard, and
the first terminal device is the primary terminal device and the second terminal device is an ancillary terminal device.

8. The method as claimed in claim 1, wherein the method is used while the data transmission system is being started up from the off state or at least an inactive state.

9. A method for establishing the necessary transmission power in a data transmission system which has a first terminal device and a plurality of second terminal devices between which data are transmitted by radio, comprising the steps of:
(a) transmitting consecutive test data packets to each second terminal device by the first terminal device, with the transmission power in the first terminal device rising in prescribed fashion over time until the first device has received from each of the second terminal devices a reception confirmation data packet which has been transferred in line with method step b),
(b) transferring a reception confirmation data packet from one of the second terminal devices to the first terminal device following reception of a test data packet, subsequently called initialization data packet, for the first time and further processing of the initialization packet by the respective second terminal device, and
(c) storing the respective transmission power required for reception for each of the second devices in a table.

10. The method as claimed in claim 9, wherein the stored transmission power is used for later connection setup to the respective second device.

11. The method as claimed in claim 9, wherein the first terminal device sends further data packets to a second terminal device using a transmission power which is determined by the initialization data packet associated with this second terminal device.

12. The method as claimed in claim 9, wherein
the data transmission system is based on the Bluetooth standard,
the first terminal device is the primary terminal device and the second terminal devices are ancillary terminal devices, and
the primary terminal device operates in the Bluetooth-specific inquiry mode during method steps a) to c).

13. The method as claimed in claim 9, wherein the method is used while the data transmission system is being started up from the off state or at least an inactive state.
